(19) United States
(12) Patent Application Publication
(10) Pub. No.: US 2005/0080645 A1
(43) Pub. Date: Apr. 14, 2005

(54) Systems and methods for providing information for collectibles

(76) Inventors: Mary C. Counts, Smyrna, GA (US); Jeffrey D. Mullen, Scarsdale, NY (US)

Correspondence Address: FISH & NEAVE IP GROUP;ROPES & GRAY LLP, 1251 AVENUE OF THE AMERICAS FL C3, NEW YORK, NY, 10020-1105, US

(21) Appl. No.: 10/888,601

(22) Filed: Jul. 8, 2004

Related U.S. Application Data
(60) Provisional application No. 60/485,832, filed on Jul. 8, 2003.

(51) Int. Cl. G06F 17/60

(52) U.S. Cl. 705/1

(57) ABSTRACT

A method of categorizing and displaying information related to collectibles is provided. Such information is provided in a compact manner and includes many useful pieces of collectible-related data. Collectible information may also be displayed, for example, on a virtual medium such as a webpage. Such virtual information may be autonomously updated from a variety of information sources. Furthermore, a user can add collectibles to a virtual collection while searching through, for example, a virtual price guide. An autonomous printing press is also provided that updates collectible information for use in the printing process before the printing process begins (e.g., updates pricing informing for a monthly price guide before a monthly price guide is printed).

### CROSS-REFERENCE TO RELATED APPLICATION

This non-provisional application claims the benefit of provisional Application No. 60/485,832, filed on Jul. 8, 2003 and entitled “Systems and Methods for Providing Coin Information,” which is hereby incorporated by reference herein in its entirety.

### BACKGROUND OF THE INVENTION

Collectibles such as trading cards, coins, teddy bears, and action figures have traditionally been catalogued in the form of price guides. One example of a traditional price guide for basketball cards is “Beckett: Basketball Card Price Guide” by Beckett Publications of Dallas, Tex. These price guides occasionally organize collectibles into groups that are organized in alphabetical or chronological order.

Price valuations are also provided for each collectible in the price guide. The price valuations for a given collectible, however, are determined either by the author or a panel of experts on that collectible. As a result, traditional price valuations for a collectible are not representative of the current market for that collectible. Therefore, it is desirable to provide a pricing valuation for a collectible that is representative of the actual market for that collectible.

Additionally, traditional collectible price guides are published on an annual or monthly basis. Thus, traditional price guides are deficient because they do not provide real-time prices for a collectible. It is therefore desirable to provide a price guide with real-time prices.

Furthermore, price valuations are usually the only form of information provided for a given collectible (other than a name identifying a particular collectible). It is therefore desirable to provide a listing for each type of collectible that provides more information about the collectible then just a price valuation.

Grading companies exist that may evaluate and encapsulate, for example, a collectible into a tamper-proof holder. During the evaluation process, such grading companies may determine the quality of that collectible and assign a particular grade (e.g., level of quality) to that collectible. Additionally, some grading companies may keep records of this information and publish this information on their website. For example, Professional Sports Authenticators (PSA) of Newport Beach, Calif. 92658 publishes a table for each category of collectibles (e.g., 1948 Bowman basketball cards) and lists the population of each type of collectible in that set (e.g., each 1948 Bowman George Mikan basketball card) that has achieved a particular grade (e.g., “GEM MINT 10” or “PSA 10”). However, such listings are deficient because only a limited amount of information is displayed to a user for each type of collectible.

### SUMMARY OF INVENTION

It is therefore an object of the present invention to provide a compact and informative way to categorize, display, and price collectibles.

In one embodiment, a collectible information layout (e.g., a collectible listing) is provided for a collectible that includes a variety of different types of information. This collectible information listing may be categorized, and employed, in, for example, a traditional paper-based price guide or as part of an online information database that is accessible through a web-browser (e.g., published through a web server as a virtual collectible layout/listing). Such information types (e.g., data types) may include, for example, descriptive text, full-color pictures of multiple perspectives of the collectible, an identification number, variation information, material composition, rarity information, population, times-at-auction, last auction sale information (or other auction information), and prices for a variety of different conditions.

Third parties may be utilized as sources of collectible-related information. For example, the information that a grading company has for each particular collectible may be utilized. Furthering this example, the number of times a type of collectible (e.g., a 1961 Fleer Basketball Card of Jerry West) has been graded may be utilized, at least in part, to determine, or estimate, that collectible's rarity and/or population (e.g., population for a grade or population for a type). As per another example, auction houses records may be utilized, at least in part, to determine, or estimate, the price that a type of collectible would sell for (or could be bought for).

The amount of data that is provided in a collectible information listing may be to maximize the amount of collectible information listings that may be included on, for example, a page or the visible portion of a web-browser listing. Pictures having perspective views (e.g., the front and back) of the collectible are also preferably included for each collectible information listing in order increase the amount of information that a user can obtain from a collectible information listing.

Collectible information listings of the present invention may also be interactive. An internet-based interactive collectible information listing system may, for example, allow a user to input information about a collectible. In this manner, such a system may allow a user to save information for a collectible to a remote database—a database that is accessible to other users. As a result, a user may browse an interactive price guide, determine which collectibles the user is in possession of, and then create a “virtual collection” so that the user may keep track of, for example, the value of the user's entire collection. In turn, the system may be operable to provide, for example, a better estimate as to the rarity of a particular collectible to other users (or other types of collectible information such as pictures).

A user, or a publisher, may customize the information data types displayed to a user for each type of collectible listed on an internet-based collectible information guide. In doing so, a user, or a publisher, may then print a customized collectible information guide that includes, for example, only selected categories and/or listings in a customized layout.

Internet-based collectible information guide data may be stored in a remote database or in remote memory. Third parties such as online auction houses and grading services may directly update (or utilize) certain types of information stored in such a remote database. Alternatively, a program may be employed that searches the database of a third party (e.g., the eBay website) and copies the third parties' collectible-related information (e.g., a current eBay price for a collectible) into an interactive collectible information database. In this manner, an interactive collectible information guide may provide real-time collectible-related information.

The price of a collectible may also be predicted. For example, the overall change in price for a period of time for that collectible (e.g., the last five years) may be determined. This predicted price change by be displayed on an information listing/layout as, for example, a percentage). Furthermore, the price of a type of collectible may be changed by the predicted price change and this information may be displayed on an information listing/layout as a predicted price. A predicted price date may also be displayed next to a predicted price and may be equivalent, to, for example, the current date plus the period of time (e.g., 5 years) that was evaluated.

### BRIEF DESCRIPTION OF THE DRAWING

The above and other features of the present invention, its nature and various advantages will be more apparent upon consideration of the following detailed description, taken in conjunction with the accompanying drawings, in which like reference characters refer to like parts throughout, and in which:

FIG. 1 is an illustration of a layout of collectible information listing constructed in accordance with the principles of the present invention;

FIG. 2 is an illustration of a collectible information book constructed in accordance with the principles of the present invention;

FIG. 3 is an illustration of a network topology of a collectible information sharing network constructed in accordance with the principles of the present invention;

FIG. 4 is an illustration of screen-shot of two virtual collectible information listings-displayed on a graphical user interface constructed in accordance with the principles of the present invention; and

FIG. 5 is an illustration of flow charts for processes constructed in accordance with the principles of the present invention.

### DETAILED DESCRIPTION OF THE INVENTION

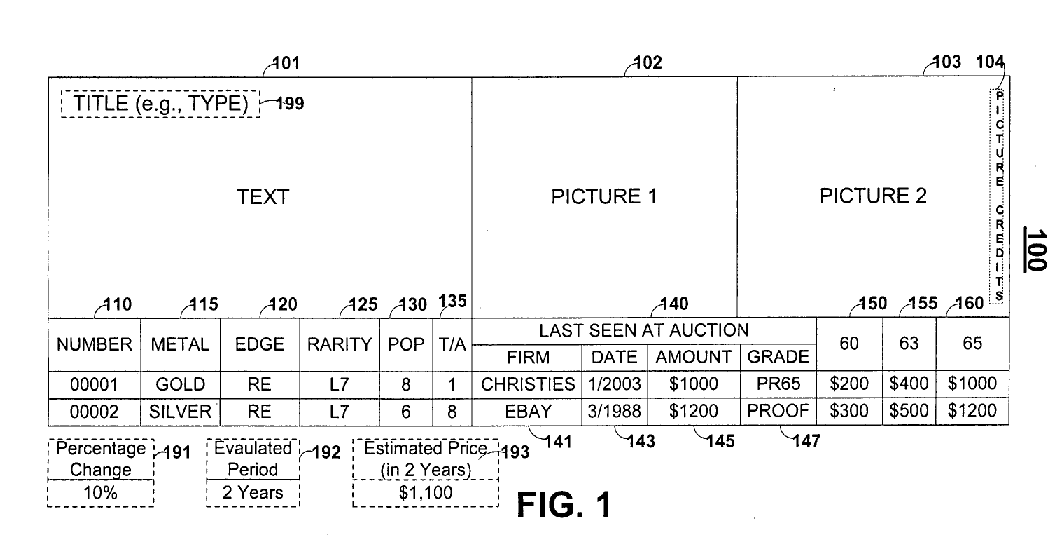

FIG. 1 shows collectible information listing 100 that may include text description 101, image 102, image 103 (and image source 104), and a variety of additional information for a type of collectible. Throughout this application the term “listing” and “layout” are used interchangeably.

As shown, collectible information listing 100 is tailored as a collectible coin information listing. As a result, collectible information listing 100 includes data fields that are tailored to a particular type of collectible. For example, metal data field 115 may not be an informative data type for beanie babies. Persons skilled in the art will appreciate that information listing 100 may be tailored for a specific collectible and, in this manner, may include additional, or different, data fields than those included in information listing 100.

Additional collectible-related information may be provided. Such information may include, for example, coin designator 110, composition type 115, edge type 120, rarity type 125, population 130, T/A (times at auction) 135, auction information 140, and condition-related prices 150, 155, and 160.

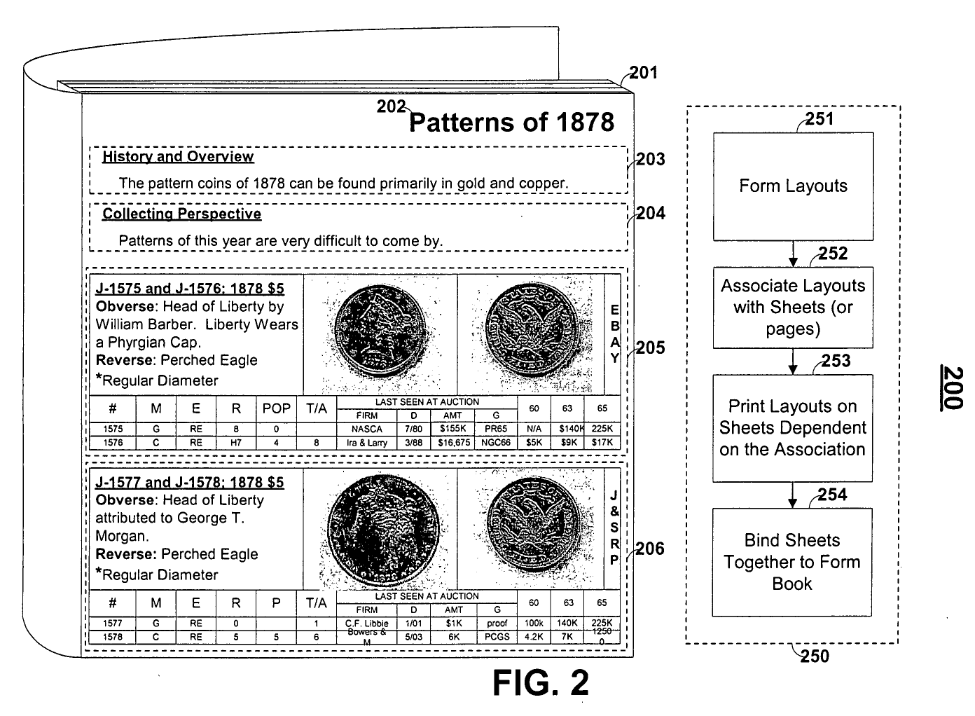

For the purposes of this application, a type of collectible is generally a specific collectible (e.g., a 1948 Bowman George Mikan basketball card is a different type of collectible then a 1957 Bowman Joe Fulks basketball card). A type of collectible may have different variations (e.g., a 1948 Bowman George Mikan basketball card may have a colored or grey background). In turn, each variation, or each type of collectible, may have a different identification (e.g., identification 110). Additionally, each possible grade (or other characteristic) may have its own identification (e.g., identification 110). For example a “GEM MINT 10” 1948 Bowman George Mikan basketball card may have a different identification than a “MINT 9” 1948 Bowman George Mikan basketball card. Persons skilled in the art will appreciate, however, that variations for some collectibles are types in and upon themselves. For example, in coin collecting, coins fabricated in different metals may have different types (e.g., types 199). As long as such different types of collectibles have substantially similar appearances, for example, the different types of collectibles may be grouped in a single listing/layout (e.g., J-1575 and J-1576 are both grouped in listing 205 of FIG. 2).

One advantage of the present invention is to provide an improved listing/layout that includes images/pictures of multiple perspectives of a collectible for each listing. For example, each card in a 1948 Bowman basketball card set may include a listing/layout for each card in the set. In turn, multiple images, and auction information, for each card in the set may be displayed.

Collectible information listing 100 may include an image of a particular perspective of a collectible. For example, image 102 may be provided as a picture of the front (e.g., the obverse side) of a type of collectible (e.g., the obverse side of a coin or card). Additional images of additional perspectives of a collectible may also be included in listing 100. For example, image 103 may be provided which may, in turn, be a picture of the rear (e.g., the reverse side) of a collectible (e.g., the obverse side of a coin or card).

Text 101 may be also be included to describe a particular collectible. Text 101 may take the form of, for example, a description of a collectible, the history of the collectible, or collecting tips about that collectible. Material information and edge-type may also be utilized for particular collectibles (e.g., coins). In this manner, data types 115 and 120 may be added.

Rarity information 135 may also be provided. Rarity information 135 may, for example, be the total number known to exist. Such rarity information may be provided as a rarity designator. For example, Rarity-1 may be representative of the fact that more than 1,250 are known to exist. R-2 may be representative of the fact that 501-1,250 are known. R-3 may be representative of the fact that 201-500 are known. R-4 may be representative of the fact that 76-200 are known. R-5 may be representative of the fact that 31-75 are known. Low R-6 may be representative of the fact that 21-30 are known. High R-6 may be representative of the fact that 13-20 are known. Low R-7 may be representative of the fact that 7-12 are known. High R-7 may be representative of the fact that 4-6 are known. R-8 may be representative of the fact that 2 to 3 are known. Unique may be representative of the fact that only one is known. Such rarity information 125 may be determined by an expert or panel of experts. Rarity information 124 may also be determined as a result of information obtained from collectors of a virtual collecting community and/or one or more third-party information suppliers (e.g., grading services or retailers).

Population information 130 may correspond to, for example, the number of times a particular collectible (e.g., a coin, paper money, card, or comic) has been graded by one or more particular grading services (e.g., a coin, paper money, card, or comic). Alternatively, population information 130 may correspond to an estimation of the number of a particular collectible expected to exist. Such an estimation may be made, for example, by taking the number of collectibles found during a period of time, determining a trend or percentage change for that period of time, and determining an expected population representative of that trend for a period of time. Moreover, population information 130 may correspond to, or include, the number of times a particular collectible has been selected to be in an interactive collection (or is currently stored in an interactive collection). A population may include population information from a variety of sources and may correspond to the population of a type of collectible, a variation of a collectible, or a grade (e.g., condition or quality) of a type of collectible.

Times at auction information 130 may, for example, correspond to the number of times a collectible has been brought to auction. Times at auction information 130 may include auction information from one or more specialized auction houses (e.g., Mastronet primarily auctions sports cards, sports memorabilia, and Americana), continuously operating internet-based auction houses (e.g., eBay or Yahoo auctions), or both. Additional information may be included in listing 100 (or somewhere in a book or website hosting listing 100) that describes where times at auction information 130 originates from. Similarly, the method utilized to obtain a particular type of information (e.g., population information 130) may be also be included.

Auction information 140 generally includes the information about a particular auction sale for a particular collectible. More particularly, auction information 140 may include for example, association/firm name 141, date of auction 143, amount realized 145, and coin condition 147.

More than one instance of auction information 140 may be included for a type of collectible. For example, association/firm name 141 may correspond to times at auction information 135 such that times at auction information 135 represents the number of times association/firm 141 sold a type of collectible. In this manner, “X” instances of auction information 140 may be included where “X” is equivalent to, for example, times at auction 135. Such “X” instances may be limited by a particular threshold “Y” (e.g., 5 instances of auction information 140). If the amount of instances of auction information 140 are limited for a type of collectible (e.g., ID 110), then a particular set of instances of auction information 140 may be chosen from the set of available instances of auction information 140. For example, only the “Y” instances of “X” instances that obtained the highest price 145 may be displayed. Alternatively, only the “Y” instances of “X” instances that have the most recent date 143 may be displayed. More complicating selections may be based on multiple criteria. For example, a particular collectible selling for the highest price 145 for “Y” grades 147 may be displayed.

Furthermore, an price may be predicted for a particular time in the future. In this manner, prediction information 191, 192, and 193 may be included in layout 100. Such prediction information may include, for example, a graph representative of the prices that the collectible has sold for over a period of time. Trends in the price changes of a collectible's sales history may be utilize to predict a change (e.g., price change 191) over a period of time (e.g., evaluation period 192) to estimate a price at a time in the future (e.g., estimated price 193).

Operations performed on data may be accomplished, for example, by a processor located on a local (e.g., a printing press) or remote system (e.g., a remote database). In this manner, a processor, or computer algorithm stored in memory, may be utilized to determine, and format, listing 100 such that the appropriate, and possibly most recent, information is displayed in listing 100. In this manner, listing 100 may be, for example, displayed on a computer or webpage. Alternatively, information for listing 100 may be obtained and physically printed on a medium (e.g., a book or a page).

Additional pricing information 150, 155, and 160 may be included in a layout/listing. Such additional pricing information may be determined by an expert or a group of experts. Alternatively, such pricing information may be associated to characteristics of a type of collectible (e.g., a particular grade). Additional pricing information may also be based on prices realized at auction. For example, additional pricing information may be an aggregate representation of a set of auction prices while auction information 140 may be the pricing information for one specific auction.

FIG. 2 shows book 200 that includes multiple instances of layout 100 of FIG. 1. Particularly, layout 100 of FIG. 1 may be included on any page 201 of book 200 as layouts 205 and 206 which may, in turn, be provided in categories (e.g., category 202). Additional information may also be included, for example, underneath each category heading but before the listing of associated layouts. Such additional information may include the history, overview, and collecting perspective information for the category (e.g., information 203 and 204). A book may, for example, be limited to a family of collectibles (e.g., coin patterns or basketball cards). In this manner, a book may have a particular subject, or theme, and include information listings/layouts for collectibles that fit that subject, or theme. Book 200 may also be provided as a virtual book. Such a virtual book may be distributed, for example, over the internet or on a computer-readable medium (e.g., a CD or DVD) with program logic included thereon for generating, or displaying, a virtual book.

Persons skilled in the art will appreciate that fabricating a book (e.g., a price guide) may occur as follows. Layouts for each type of collectible may be printed on sheets (or pages). These sheets (or pages) may then be bound together (e.g., glued or stapled) to form the book. One or more book covers may also be bound to the sheets (or pages). More particularly, a printing process may take the form of process 500. Particularly, layouts for types of collectibles in, for example, a family of collectibles may be formed in step 251. Forming layouts may include, for example, generating a printing mold (e.g., a mechanical representation of a layout) or a virtual layout (e.g., an electrical representation of a layout). Such layouts may then be associated with particular sheets (or pages) in step 252. Persons skilled in the art will appreciate that a book may be fabricated by folding sheets to form pages and then binding these folded sheets together. If a layout does not fit on a page (e.g., the layout is too large for a page or cannot fully fit on a page because of other layouts or information on a page) then a layout may be split among different sheets, different portions of sheets, or different pages. Layouts may also be organized into separate columns or rows on a sheet, portion of a sheet, or page. Next, the organized layouts are printed on their respective sheets in step 253. After the layouts are printed, the sheets (or pages) may be bound together at step 254.

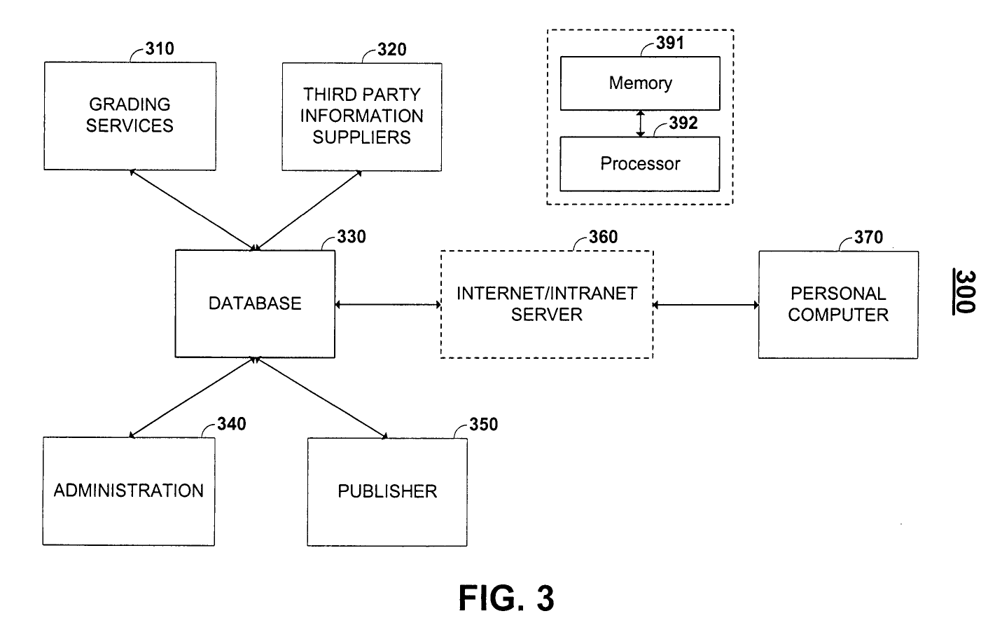

FIG. 3 shows network topology 300 for providing coin information to, and gathering coin information from, a variety of systems. Database 330 may be included in network topology 300 and may be utilized as a hub for communicating information for a collectible between a variety of systems. Persons skilled in the art will appreciate that multiple databases 330, or any other type of data storage device, may be utilized to store any portion of collectible-related information.

Additional systems that may be included in network topology 300 may be, for example, grading services 310, third-party information suppliers 320, administration 340, publisher 350, internet server 360, and personal computer 370.

Grading services 310 services may be included, for example, to write information into, or retrieve information from, database 330 for a collectible. For example, grading services 310 may be a coin grading service or a database storing information for a coin grading service. In this manner, grading service 310 may upload the population of a coin to database 330 at a particular time or when that population changes. The population may be, for example, dependent on a particular type of collectible (e.g., a 1957 Topps Nat Clifton basketball card) or a particular grade for a particular type of collectible (e.g., a “GEM MINT 10” 1957 Topps Nat Clifton basketball card).

Third-party information suppliers 320 may be included to, for example, provide additional information related to a collectible included on a collectible listing. Such third-party information supplies 320 may include, for example, auction houses or collectible retailers.

A program may be included (e.g., in database 330 or a processor communicating with database 330) that periodically checks a certain category (e.g., graded coins) or a certain type of collectible (e.g., a “MINT 9” 1948 Bowman George Mikan basketball card) for information about current, or recently-ended, auctions. Such a program may, for example, retrieve and store this information in database 330. Alternatively, such a program may just send this information to database 330 (e.g., if the program is utilized by suppliers 320). Such online auction houses may also access database 330 at the beginning of an auction in order to make buyers aware of the market for a collectible. For example, an online auction house may check, or may prompt a user initiating an auction, to check database 330 for recent sales information about the collectible. When an auction listing is created, at least part of the information contained in database 330 about the collectible (e.g., coin) may be integrated into the online auction listing.

Third-party information suppliers 320 may also include retailers of collectible information. For example, third-party information suppliers 320 may be, for example, a collectible store. Such a collectible store may be provided (e.g., may download from a website) a program in which an operator may enter in, via a Graphical User Interface (GUI), information for a type of collectible. For example, an operator may enter in the number of a type of collectible the collectible store has. As per another example, an operator may enter in information about a recent transaction for a particular collectible (e.g., how much a type of collectible sold for and when). To confirm that such an inventory, or such a transaction occurred, the operator may be able to (or may be required to) upload a picture of the particular collectible and any transactional records (e.g., receipts). Persons skilled in the art will appreciate that such a program may also be used with individual collectors/users, or other systems of topology 300, and is not limited to suppliers 320.

A compensation program, or system, may also be utilized in order to, for example, encourage suppliers 320 to provide collectible information. For example, a particular price (e.g., $1.00 ) may be paid for a particular type of information (e.g., a picture of a type of collectible that database 330 does not have or information about 100 transactions).

Information from database 330 may be provided through the internet. For example, internet server 360 may generate a webpage to personal computer 370 from database 330 such that collectible information stored in database 330 is displayed on personal computer 370.

An administrator, or authorized user, may directly access, manipulate, write, read, and reconfigure database 330 from administration system 340 which may be, for example, a personal computer. Administration system 340 may also be operable to operate, or change the operation of, any of the systems of network topology 300.

Publisher 350 may utilize database 330 when creating, for example, a price guide or a new revision (e.g., a 2004 update) of a price guide. Similarly, publisher 350 may utilize database 330 (or multiple databases 330) to obtain information for a publication. A program may be included at publisher 350 that retrieves information for a type of collectible from database 330 and automatically generates layout similar to layout 100 of FIG. 1 for that type of collectible. Publisher 350 may be, for example, a computer system located at a publisher or the processor of a printing press.

Processor 392 and memory 391 may be included in any system of topology 300 to perform the functions described herein. Moreover, processor 392 and memory 391 may be provided in other systems that may communicate with the systems of topology 300. Persons skilled in the art will appreciate that any system of topology 300 may communicate data to other systems of topology 300 (or systems external to topology 300) either directly or via a webpage.

Users may also access database 330 from, for example, personal computer 370 or a wireless communications device. Database 330 may be accessed by such users through internet (or intranet) server 360. Such users may be required to enter a login or password and may be required to pay a one time fee, pay a fee every time the service is used (e.g., information is refreshed), or pay periodic subscription fees for access to database 330.

Users of, for example, personal computer 370 may customize the information that is obtained from database 330. For example, a user may pick a sub-set of available collectibles (e.g., types of coins) and a sub-set of available data types (e.g., the information types of listing 100 of FIG. 1). A webpage may then be generated that includes the selected information for the selected collectibles. In this manner, a user may, for example, build a virtual collection and/or a “watch list” of collectibles the user is interested in.

The number of times that a user refreshes, or requests, the displayed information may be recorded. Accordingly, a third party information supplier 320 (e.g., grading services 310) may be paid a commission for their coin-related information based on the demand for that collectible information. The user may be able to configure the type of data displayed. For example, if a user is only interested in the rarity of a coin then that user may configure the webpage such that only the population reports from graded service companies are displayed.

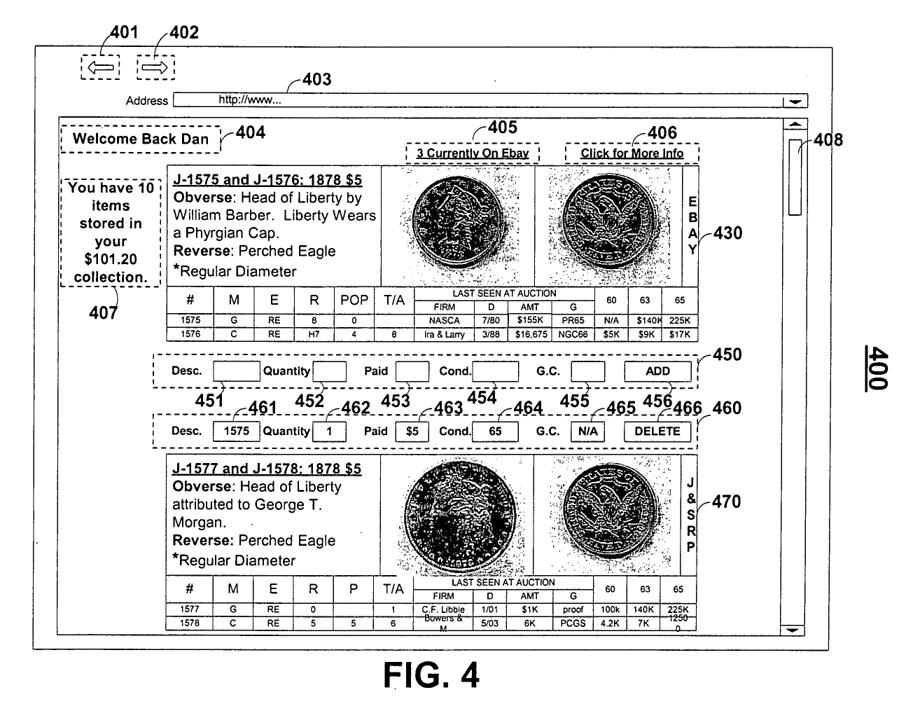

FIG. 4 shows Graphical User Interface (GUI) 400. GUI 400 may be accessible through for example, the internet, an intranet, or a local memory. In this manner, GUI 400 may take the form of a interactive or static (e.g., not interactive) web-browser or display screen. GUI 400 may include layout 430 and 470. Layouts 430 and 470 may be similar in content, and appearance, to layout 100 of FIG. 1. Added functionality, however, may exist in layout 430 and 470 as a result of being virtual. For example, by connecting the database/web server publishing layouts 430 and 470 to a third party with real-time collectible prices (e.g., eBay) the price data fields of layouts 430 and 470 may be updated in real-time and presented to the user via the internet.

Preferably, GUI 400 is a webpage in which the data utilized in GUI 400 is stored in a remote database, formatted by and interactive through a software application, published to a webpage by a web server, and accessible through the internet. Virtual tools 401-403 and 408 may be provided to help a user navigate through the application or the internet.

Users of GUI 400 may have a login/password. As a result, virtual GUI 400 may be customized by a user and these customizations may “follow” the user as he/she accesses virtual GUI 400 through different types of hardware (e.g., a cell phone, PDA, laptop, personal computer). As per one type of customization, the data fields that are displayed to a user for a particular layout 430 and 470 may be changed by a user.

Moreover, tools 450 and 460 may allow a user to keep track of his/her collection. Tool 450 may, for example, allow a user to add, to a portion of memory in a remote or local memory associated to the user, description 451, quantity 452, price paid 453, condition 454, and other information 455. A similar customization tool 450 may be provided for each layout of GUI 400. Tool 460 may be provided to display collectible information retrieved for a particular user for a particular layout that was previously stored by that user for that particular layout.

In this manner, collection management tool may be provided to a user to tell the user information about his/her personal collection for a particular collectible. For example, collection management tool 360 may be provided for layout 430. Similarly, a collection management tool may be provided such that a user may enter information about his/her personal collection for a particular collectible. For example, collection management tool 350 may be provided for layout 430. Persons skilled in the art will appreciate that collection management tools 450 and 460 may be provided as a single collection management tool.

Tools 460 (or tools 450) may also be used to display collectible information for different users for a particular layout. In this manner, button 466 may take other forms such as, for example, a “contact/email” user button or a “trade/buy/sell” button. In this manner, the layouts and tools of the present invention may be utilized to realize a collecting community.

As a result of such collection management tools, a user that had previously stored collection-information for the collectible(s) of layout 430 on a remote database (or locally in the memory of a personal computer) via collection management tool 450 may be provided with the stored information in tool 360 when layout 430 is displayed. Alternatively, information stored or manipulated by collection management tools may be incorporated into layout 430. In this manner, a collection management tool may also be utilized as a customization tool. Such additional information may be utilized to update associated information on a remote database such that other users may view an updated layout 430.

Any information utilized in a virtual layout may be manually adjusted by a user (and stored locally or remotely for that user) or an administrator (and utilized to update a remote database accessible by all/some users). Similarly, particular users may be given administration rights for particular layouts such that any manual adjustments made by those users are utilized to update a remote database that is accessible by all/some users. In this manner, a collector who has written an article on the rarity of a particular collectible (e.g., a 1968 Topps Test basketball card article) may be given access to update layouts associated to the individual cards of the 1968 Topps Test basketball card set.

Collection management tool 460 may include, for example, description 461, quantity 462, price paid 463, condition 464, other information 465. A delete/modify button 466 may also be provided that allows a user to delete/modify the data fields of tool 460. One or more tools 450 and tools 460 may be provided for each collectible listing/layout of GUI 400. Alternatively, a tool 460 may only be displayed for a collectible listing/layout in which information has been previously stored by a user (or, in a collecting community, any user).

Collection information 407 may be displayed to a user and may include information such as, for example, a summary of the information stored in one or more collection management tools 460. Generally, collection information 407 may include a summary of the collectible information for a particular user (or a particular group of users). Persons skilled in the art will appreciate that the information of a particular collection management tool may be the information stored in a remote, or local, memory for a particular user. A particular user may also set-up a profile that contains user information. Such user information may be utilized to customize GUI 400 (e.g., portion 404).

Each virtual layout 430 and 470 may include, for example, one or more third-party online search results 405. For example, the title of layout 430 (e.g., J-1575 and J-1576) may be used as a third-party search parameter (e.g., eBay) where clicking on results 405 displays information from that third-party search to the user. For example, clicking on results 405 may display an eBay search for the collectible of layout 430 (e.g., J-1575). Such searches may be utilized to generate customized versions of results 405. Particularly, a search for the collectible of layout 430 (e.g., J-1575) may be performed before, or as, layout 430 is displayed to a user such that results 305 displays a summary of the search results with layout 430.

A compensation scheme may also be utilized with this functionality. Particularly, a record may be made of the number of transactions that occur as the result of the use of results 405 for a particular third-party (or the additional revenue acquired by that third-party because of results 405). In this manner, a third-party may provide commission to, for example, the owners of the collectible information exchange system based on the use of results 305.

Additional third-party information that is accessible through the internet may be provided by link 406 for layout 430. Clicking on link 406 may, for example, provide a real-time population report for the coin as reported by a third-party grading service.

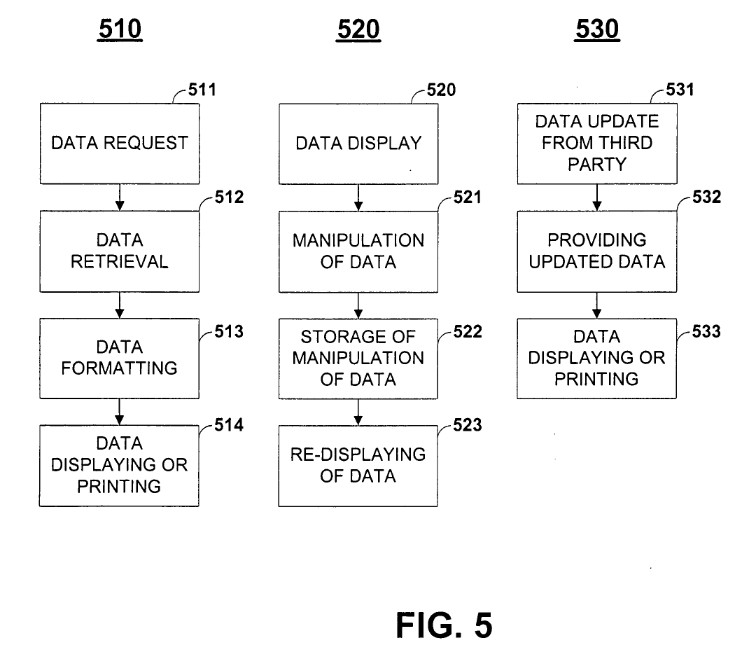

Turning next to FIG. 5, flow charts 510, 520, and 530 are shown that include a variety of processes that may be utilized in a variety of different ways.

Flow chart 510 may begin with step 511 in which collectible data is requested. For example, a layout for a type of collectible may be requested or a specific information data type (e.g., population) for a type of collectible may be requested. After the collectible data is requested, the collectible data is located and retrieved in step 512. The collectible data may be retrieved either locally or remotely (e.g., via a remote database or system). After the collectible data is retrieved, formatting step 513 may be implemented. Particularly, the collectible data may need to be utilized to construct a layout. Next, the data is displayed or printed in step 514.

Persons skilled in the art will appreciate that a publisher may utilize the collectible information of the present invention to print a book that includes such collectible information. For example, a printing press may autonomously download and format predetermined collectible data to update, or generate, layouts for a particular book. Alternatively, collectible data may be manually inputted (e.g., downloaded) into a printing press such that the printing press may update, or generate, layouts for a particular book.

Moreover, specialized layouts may be downloaded into a printing press such that the printing press may print out the layouts on a physical medium (e.g., paper). For example, layout 100 of FIG. 1 may be printed on physical paper as the result of the manual input of the collectible information of layout 100, or the input layout 100 itself, into a system/component of a printing press. Layout 100, as shown, is highly specialized. For each type of collectible (e.g., a collectible having its own title 199 of FIG. 1 with any number of variation IDS 110 of FIG. 1), a specialized layout similar to layout 100 may be printed. Such specialized layouts include information not present in any traditional collectible information guides (e.g., pictures of both the front and back for every type collectible and auction information). For this reason, printed layouts such as, for example layout 100 of FIG. 1, are highly functional as they provide a compact way of displaying critically important information about a collectible. As a result, a printing press may fabricate a highly-functional book (e.g., book 200 of FIG. 2) that organizes types of collectibles into categories (e.g., set) for a particular subject (e.g., basketball cards) in which a layout (e.g., layout 100 of FIG. 1) is printed for each type of collectible.

Flow chart 520 may start with step 520 in which collectible data is displayed. Such collectible data may be manipulated by a user in step 521. Alternatively, collectible data may be autonomously manipulated by, for example, and updating program (e.g., a period updating based on third-party information updates). After collectible data has been manipulated, the manipulated collectible data may be stored in step 522. Such a storage may occur locally (e.g., storage of a user's collection data) or may occur remotely (e.g., storage of an operator's transactional data). Generally, remotely-stored data is data that is accessible to systems other than the system in which the data is stored. Next, the manipulated data may be re-displayed (e.g., updated on a remote user's display or initially displayed on a remote user's display).

Flow chart 530 starts with process step 531 in which collectible data is updated by a third-party. Such an update may occur, for example, periodically (e.g., every night at midnight), when new information is present, when a particular amount of new information is present, or when an update is requested. Updated collectible data may be provided in step 532 and displayed (or printed) in step 533. For example, suppose a printing press printed a monthly price guide for a collectible. That printing press may autonomously, for example, wait until the last possible moment to receive collectible information (e.g., the moment the printing must be started minus the time it may take to download and/or format collectible information data stored in a database or memory). Such a printed monthly price guide may, for example, include an improved functionality because the layouts of the printed monthly price guide may contain information more representative of the actual price of a collectible.

From the foregoing description, persons skilled in the art will recognize that this invention generally relates to the organization, categorization, display, and storage of coin related information. In addition, persons skilled in the art will appreciate that the various configurations described herein may be combined without departing from the present invention. It will also be recognized that the invention may take many forms other than those disclosed in this specification. For example, the above cataloging and information collecting/dispersal techniques may be utilized with, for example, antiques, cars, sports cards, paper money, or any other collectible item. Accordingly, it is emphasized that the invention is not limited to the disclosed assemblies and methods, but is intended to include variations to and modifications therefrom which are within the spirit of the following claims.

1. A method of printing a price guide for a family of collectibles, wherein said family of collectibles includes several types of collectibles and said price guide includes several sheets, said method comprising:
printing several layouts onto said several sheets, wherein each one of said several layouts is associated to one of said several types of collectibles and said each one of said several layouts comprises;
an image of a first perspective of said one of said several types of collectibles;
an image of a second perspective of said one of said several types of collectibles;
a text description of said one of said several types of collectibles;
auction information for said one of said several types of collectibles, wherein said auction information comprises;
a first price;
a first date;
a first auction house name;
additional pricing information for said one of said several types of collectibles; and
binding said several sheets together to form said price guide.

2. The method of claim 1, further comprising associating said several layouts to at least one of said several sheets, wherein said printing is based on said association.

3. The method of claim 1, further comprising updating said auction information before said printing.

4. The method of claim 1, further comprising updating said additional pricing information before said printing.
